(19) United States
(12) Patent Application Publication
(10) Pub. No.: US 2009/0043938 A1
(43) Pub. Date: Feb. 12, 2009

(54) SYSTEM FOR MEASURING AND OUTPUTTING AN ELECTRIC QUANTITY

(75) Inventor: Martin WECHSLER, Furth (DE)

Correspondence Address: Henry M. Feiereisen;Henry M. Feiereisen, LLC, Suite 4714, 350 Fifth Avenue, New York, NY, 10118, US

(73) Assignee: Siemens Aktiengesellschaft, Munchen (DE)

(21) Appl. No.: 11/835,749

(22) Filed: Aug. 8, 2007

(51) Int. Cl. G06F 13/14

(52) U.S. Cl. 710/305

(57) ABSTRACT

A system is disclosed which communicates a quantity derived from measured time-dependent analog electric signals to an external bus or communication interface. The system includes a basic unit with a digitizer for converting the time-dependent analog signals into digital signal data, and at least one processor for computing the quantity from the digitized signals. A bus-specific adapter interfaces the digitized signals from the basic unit with the external bus. The adapter has an interface to the basic unit that is independent of the corresponding external bus and another interface to the external bus that is specific to the external bus. The adapter operates as a master and the basic unit operates as a slave. The adapter is advantageously implemented as a module separate from the basic unit, but which is easily attachable to the basic unit for easy exchange for configuring the system for different external buses.

### BACKGROUND OF THE INVENTION

The present invention relates to a system for measuring and outputting an electric quantity of time-dependent electric analog signals in form of at least one time-dependent current curve and at least one time-dependent voltage curve.

Nothing in the following discussion of the state of the art is to be construed as an admission of prior art.

A system for monitoring electric power is intended to determine the power as a particular electric quantity based on the current and voltage signals applied to the measurement inputs of the system. A software-controlled processor computes the power (and optionally additional electric variables) from digitized current and voltage curves using A/D converters. The power (and/or any other electric quantity) is outputted via an interface that can be connected to an external bus. Each system is typically designed for a single external bus and has a communication interface configured the bus for which the system is designed. Such a system is therefore supplied for specific bus connection, i.e., with a Profibus interface for a Profibus. As a consequence, numerous different systems must be provided due to the large number of different buses of potential interest to a purchaser of the system.

It would therefore be desirable and advantageous to provide an improved system for measuring and communicating electric power measurements, to obviate prior art shortcomings.

### SUMMARY OF THE INVENTION

According to one aspect of the present invention, a system for communicating a quantity derived from measured time-dependent analog electric signals to an external bus or communication interface includes a basic unit having a digitizer for converting time-dependent analog electric signals into digitized electric signals, and at least one software-controlled processor for computing a quantity from the digitized electric signals, and a bus-specific adapter for interfacing the digitized electric signals from the basic unit with an external bus or communication interface, said bus-specific adapter having a first interface to the basic unit that is independent of the external bus, and a second interface to the external bus or communication interface that is specific to the external bus or communication interface, wherein the adapter operates as a master and the basic unit operates as a slave, and wherein the adapter is separate from the basic unit and interchangeable as a module.

As a result of a system according to the present invention, only a single basic unit needs to be provided; with the adapter specifically configured for the respective bus, so that a system can be connected with different adapters for communicating with different buses. Each system has a common interface for the different adapters, which may be a standard interface or a proprietary interface. In this way, the costs and complexity of these systems can be reduced, because if a problem occurs with the adapter, only the adapter needs to be exchanged. New external buses can be added and/or alternative external buses can be used simply by changing the adapter. In other words, a system according to the present invention is able to specifically communicate with a large variety of different external buses, while being simple in structure and cost-effectively to manufacture.

Suitably, the adapter may be connected to the outside of the system to simplify installation, removal and/or exchange. According to another feature of the present invention, the adapter may be connected to the system by a plug-in connection.

According to another feature of the present invention, the adapter may incorporate galvanic isolation which galvanically isolates the basic unit from the external bus or communication interface. In this way, electric interference can be reliably prevented.

According to another feature of the present invention, the adapter may include a software-controlled processor, e.g. a microcontroller, to provide intelligent functionality. This further simplifies the system.

According to another feature of the present invention, the first interface may be implemented as a standardized interface for the basic unit. This reduces costs.

According to another feature of the present invention, the measured time-dependent analog electric signals may represent a voltage and an electric current, and wherein the computed quantity represents electric power.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block diagram of a system aspect of the invention connected to an external bus;

FIG. 2 shows a schematic block diagram of an adapter for the system of FIG. 1; and

FIG. 3 is a perspective view of an exemplary system with a connected adapter.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

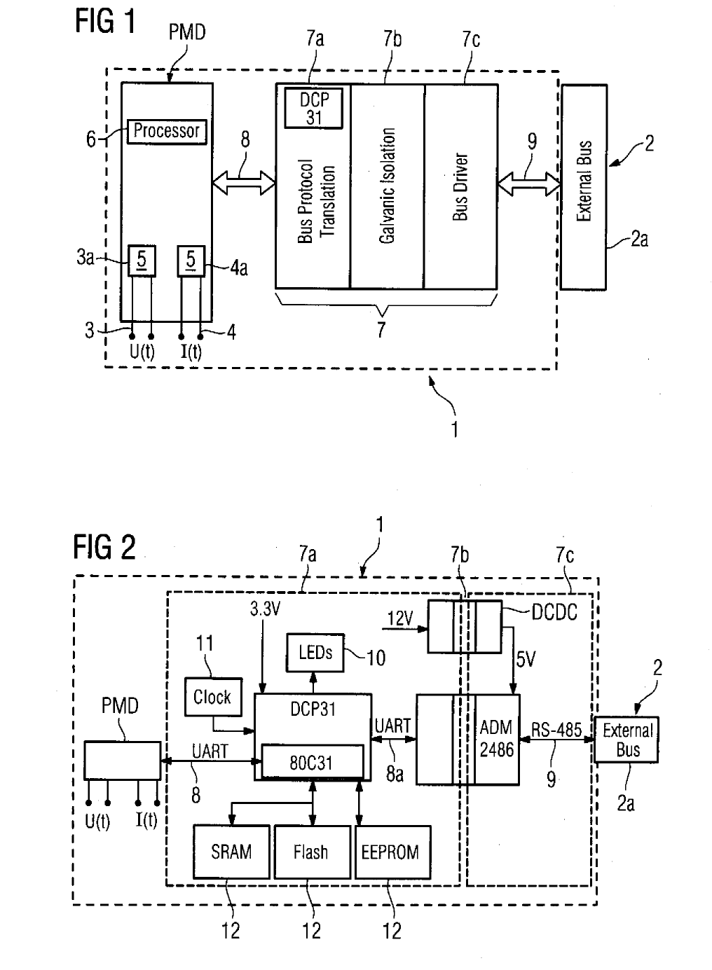

Turning now to the drawing, and in particular to FIG. 1, there is shown in form of a block diagram a system 1 for measuring and outputting electric quantities, in particular electric power or an effective value of the electric power. The effective value of the electric power or the electric power itself is to be understood as merely an example for any suitable electric quantity that can be determined and outputted. After the measurement, the measured electric power is transmitted to an external bus 2, in the present example a Profibus 2a.

The system 1 includes a basic unit PMD (Power Monitoring Device) with measurement inputs 3, 4, with an AC voltage U(t) applied to the measurement input 3 and an AC current I(t) applied to the measurement input 4. The AC voltage U(t) and the AC current I(t) are only given as examples fore more general time-dependent analog electric (AC) signals applied to the measurement inputs 3, 4. The measurement inputs 3, 4 are connected to the inputs terminals of digitizers 5 which may be implemented as a A/D converters 3a, 4a. A software-controlled processor 6 supplies the digitized time-dependent values of the AC voltage U(t) and of the AC current I(t), or of any other suitable electric signal, to an adapter 7 via an internal interface 8. It will be understood that instead of the original signals, other signals derived from the original signals can also be supplied and/or processed.

Interface 8 between the PMD and the adapter 7 is a unified interface for all types of adapters 7. The interface is “standardized” mechanically, electrically and with respect to the employed software and/or software protocol, but need not be an open standard. The interface 8 may, for example, be implemented as a MODBUS. The connector (not shown) between the PMD and the adapter may be, for example, a standard 14-pin connector.

The basic unit PMD and the adapter 7 communicate in a master-slave mode, wherein the basic unit PMD operates as a slave and the adapter 7 operates as a master, respectively. As master, the adapter 7 requests data from the basic unit PMD, in this case the digitized current and voltage curves, which are then transferred to the master from the basic unit PMD via the interface 8.

The adapter 7 enables communication between the basic unit PMD and the external bus 2 which operates with a protocol different from that of the PMD. The adapter 7 can be divided into three regions: a region 7a which provides an intelligent function and includes a software-controlled microcontroller, such as processor DPC31, a galvanic isolation region 7b, and a bus driver 7c configured for the external bus 2.

Instead of or in addition to a microcontroller, the intelligent function can also be provided by memory or an ASIC. The intelligent function implements a unique communication interface with the PMD to allow interoperability and compatibility between the different modules and the different PMDs. This interface is the same for all types of adapters 7. The intelligent function should also implement the external communication with the external bus 2, for example, a Profibus communication for a Profibus 2a.

The microcontroller, e.g., DCP31, fetches the electric quantities measured and computed by the basic unit PMD and transmits these quantities to the galvanically isolated bus driver 7c, which then outputs or provides the electric quantities to the external bus 2 via an interface 9 configured for the external bus 2.

Accordingly, the adapter 7 is connected, on one hand, with the basic unit PMD via interface 8 that is independent of the respective external bus 2 and, on the other hand, via a bus-dependent interface 9 with the respective external bus 2, for which the adapter 7 is designed. Interface 9 is especially configured for the external bus 2. A physical connector for the interface 9 may have a configuration that depends on the particular bus 2.

Although the external bus 2 is referred to as a “bus”, it may also include other types of digital and/or analog outputs. The term “bus” should therefore be generally understood as including any type of communication interface.

FIG. 2 shows a diagram of the adapter 7 illustrated FIG. 1 in more detail. For example, the internal interface 8 is here implemented as a serial interface UART, and the adapter includes a special processor core 80C31. Data are transmitted to the bus driver 7c via a second interface 8a which is also implemented as a serial interface UART. The galvanically isolated bus driver 7c, which is implemented as an ADM2486 integrated circuit, is connected to the external bus 2, for example, a Profibus 2a, via the external interface 9 (in this example RS-485). As illustrated in FIG. 2, the power supply DCDC (voltage 5 V) of the bus driver 7c is also galvanically isolated from the 12 V power supply of region 7a. The state of the microcontroller is indicated by LEDs 10; the clock frequency is determined by a quartz oscillator 11. The value 3.3 V indicate the power supply voltage of the microcontroller. The microcontroller is connected with different memory devices 12, such as an SRAM, a Flash memory or an EEPROM, or any other suitable type of memory capable of exchanging data with the microcontroller by using a variety of communication protocols.

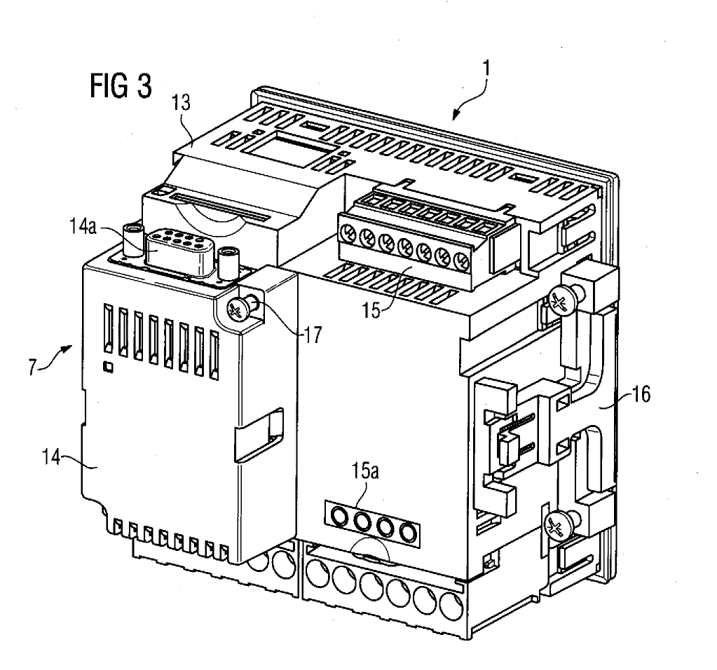

FIG. 3 shows in a perspective view a basic unit PMD having the reference symbol 13 with a separately plugged-in, and hence exchangeable, adapter 7. The adapter 7 of the depicted exemplary system 1 is configured as a module 14 which may have a connector (not shown) on the side facing the basic unit 13 which can be plugged into a mating connector 15a disposed on the housing wall facing the adapter 7. It will be understood that the illustrated connector 15a can be provided in addition to a similar connector on the housing wall underneath the adapter 7, which in the illustration is obscured from view. The illustrated adapter 7 also has a terminal 14a for connection to an external bus 2, for example a Profibus 2a. FIG. 3 shows an addition connector strip 15 as well as mounting means 16 disposed on the basic unit 13. The adapter can be attached to the basic unit 13 by any type of fastener, snap-in connections and the like, indicated schematically in FIG. 3 by the screw 17.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A system for communicating a quantity derived from measured time-dependent analog electric signals to an external bus or a communication interface, comprising:
a basic unit having a digitizer for converting time-dependent analog electric signals into digitized electric signals, and at least one software-controlled processor for computing a quantity from the digitized electric signals; and
a bus-specific adapter for interfacing the digitized electric signals from the basic unit with an external bus or a communication interface, said bus-specific adapter having a first interface to the basic unit that is independent of the external bus, and a second interface to the external bus or communication interface that is specific to the external bus or communication interface,
wherein the adapter operates as a master and the basic unit operates as a slave, and
wherein the adapter is separate from the basic unit and interchangeable as a module.

2. The system of claim 1, wherein the adapter is connected to the system by a plug-in connection.

3. The system of claim 1, wherein the adapter incorporates galvanic isolation which galvanically isolates the basic unit from the external bus or communication interface.

4. The system of claim 1, wherein the adapter comprises a software-controlled processor for providing intelligent functionality.

5. The system of claim 4, wherein the software-controlled processor comprises a microcontroller.

6. The system of claim 1, wherein the first interface is implemented as a standardized interface for the basic unit.

7. The system of claim 1, wherein the measured time-dependent analog electric signals represent a voltage and an electric current, and wherein the computed quantity represents electric power.
